(19) United States
(12) Patent Application Publication
(10) Pub. No.: US 2006/0154395 A1
(43) Pub. Date: Jul. 13, 2006

(54) Heat conductive sheet, manufacturing method of the same, and manufacturing method of a liquid crystal display using the same

(75) Inventor: Dong-won Kim, Chungcheongnam-do (KR)

Correspondence Address: David W. Heid;MacPHERSON KWOK CHEN & HEID LLP, Suite 226, 1762 Technology Drive, San Jose, CA, 95110, US

(73) Assignee: SAMSUNG ELECTRONICS CO., LTD., Suwon-si (KR)

(21) Appl. No.: 11/199,723

(22) Filed: Aug. 8, 2005

(30) Foreign Application Priority Data
Jan. 7, 2005 (KR) 2005-0001798

(51) Int. Cl. B32B 5/02; B32B 27/12; D03D 15/00; B32B 27/04

(52) U.S. Cl. 438/30; 442/189; 442/110; 442/301

(57) ABSTRACT

The present invention relates to a heat conductive sheet including: a glass fiber and a coating layer surrounding the glass fiber. The coating layer includes silicon, fluoropolymer resin, and metal. Thus, a heat conductive sheet having high durability and high heat conductivity is provided.

### CROSS-REFERENCE TO RELATED APPLICATIONS

This application claims the benefit of Korean Patent Application No. 2005-1798, filed on Jan. 7, 2005, in the Korean Intellectual Property Office, the disclosure of which is incorporated by reference herein in its entirety.

### BACKGROUND OF THE INVENTION

1. Field of the Invention

The present invention relates to a heat conductive sheet, a manufacturing method of the heat conductive sheet, and a manufacturing method of a liquid crystal display using the heat conductive sheet.

2. Description of the Related Art

Generally, an LCD device (liquid crystal display device) comprises an LCD panel having a TFT substrate (thin film transistor substrate), a color filter substrate, and liquid crystal layer injected between the TFT substrate and the color filter substrate. As the LCD device itself does not emit light, a backlight unit is provided at the back side of the TFT substrate. The amount of light emitted from the backlight which is transmitted through the liquid crystal is controlled by the alignment of the liquid crystal layer.

The LCD device further comprises a gate driving circuit, a data driving circuit, and a PCB (print circuit board) to apply a driving signal to a gate line and a data line which are laid on the TFT substrate. The PCB has a timing controller and a driving voltage generator.

The gate driving circuit and the data driving circuit are electrically connected to the LCD panel, specifically to gate pads and data pads formed on the TFT substrate. Generally, the driving circuits to be connected to the pads are formed on films, which are called TAB-IC (tape automated bonding-integrated circuit). The TAB-IC includes TCP (tape carrier package) where the driving circuit is attached onto a high molecular film, COF (chip on film) where the driving circuit is mounted on a flexible printed circuit substrate, etc.

If the TAB-IC is used, leads of the driving circuit are electrically connected to the pads on the TFT substrate by bonding using an ACF (anisotropic conductive film).

A method for bonding the leads and the pads is as follows. Firstly, the ACF is positioned on the pads of the TFT substrate. Then, the leads of the driving circuit are positioned to correspond to the pads on the TFT substrate. Thus, the ACF is positioned between the pads and the leads. Then, the pads and the leads are pressed together so that the conductive particles in the ACF may electrically connect the leads with the pads. During the bonding process, the ACF is heated by a heating tool. When the heating tool is used, a shock-absorbing sheet, such as a PTFE (polytetrafluoroethylene) sheet, may also used between the heating tool and the TAB-IC.

However, the PTFE sheet has poor heat conductivity, requiring that the heating tool maintain a high temperature during the bonding process. Also, because of the poor durability of the PTFE sheet, it is difficult to reuse the PTFE sheet for the manufacturing of subsequent LCD devices. Also, the PTFE sheet may be wrinkled, folded, or bent by heating, thereby causing misalignment between the pads and the leads.

### SUMMARY

Accordingly, it is an aspect of the present invention to provide a heat conductive sheet having high durability and high heat conductivity.

Another aspect of the present invention is to provide a method for manufacturing the heat conductive sheet having high durability and heat conductivity.

Another aspect of the present invention is to provide a method for manufacturing an LCD device using the heat conductive sheet having high durability and heat conductivity.

Additional aspects and/or advantages of the present invention will be set forth in part in the description which follows and, in part, will be obvious from the description, or may be learned by practice of the present invention.

The foregoing and/or other aspects of the present invention are also achieved by providing a heat conductive sheet comprising a glass fiber and a coating layer surrounding the glass fiber and comprising silicon, fluoropolymer resin, and metal.

According to an aspect of the present invention, the metal comprises aluminum.

According to an aspect of the present invention, the coating layer comprises 80 to 120 parts by weight of the fluoropolymer resin, 80 to 120 parts by weight of the metal, and 100 parts by weight of the silicon.

According to an aspect of the present invention, particles included in the coating layer are permeated in the glass fiber.

According to an aspect of the present invention, the glass fiber is permeated by particles from the coating layer.

According to an aspect of the present invention, the glass fiber is permeated by particles comprising at least one of the fluoropolymer resin, the silicon, and the metal.

According to an aspect of the present invention, the thickness of the glass fiber is 0.05 mm to 0.15 mm.

According to an aspect of the present invention, the thickness of the heat conductive sheet is 0.15 mm to 0.25 mm.

According to an aspect of the present invention, the tensile strength of the heat conductive sheet is 300 kgf/cm² or more.

According to an aspect of the present invention, the elasticity of the heat conductive sheet is 10% or less.

According to an aspect of the present invention, the surface electrical resistance of the heat conductive sheet is 10¹⁰Ω/cm² or less.

According to an aspect of the present invention, the fluoropolymer resin is continuous phase.

The foregoing and/or other aspects of the present invention are also achieved by providing a method for manufacturing a heat conductive sheet comprising: providing a coating composition comprising silicon, fluoropolymer resin, and metal; and hot-pressing the coating composition onto a glass fiber.

According to an aspect of the present invention, the temperature of the hot-pressing is 400° C. to 600° C.

The foregoing and/or other aspects of the present invention are also achieved by providing a method for manufacturing an LCD device comprising: providing a heat conductive sheet comprising a glass fiber, a coating layer comprising silicon, fluoropolymer, and metal; aligning leads on a lead layer coupled to a driving circuit with pads formed on an LCD panel, with a conductive film provided between the leads and the pads; positioning the heat conductive sheet adjacent to a side of the lead layer opposite the pads; and applying a pressure to the heat conductive sheet using a heating tool.

According to an aspect of the present invention, the metal comprises aluminum.

According to an aspect of the present invention, the set temperature of the heating tool during said applying the pressure is 370 to 390° C.

According to an aspect of the present invention, the temperature of the heat conductive sheet during said applying the pressure is 250 to 300° C.

### BRIEF DESCRIPTION OF THE DRAWINGS

The above and/or other aspects and advantages of the present invention will become apparent and more readily appreciated from the following description of the embodiments, taken in conjunction with the accompanying drawings of which:

FIG. 1 is a sectional view of a heat conductive sheet according to a first embodiment of the present invention;

FIG. 2 is a sectional view of a heat conductive sheet according to a second embodiment of the present invention;

FIG. 3 is plan view showing the arrangement of elements of a LCD device according to the first embodiment of the present invention;

FIG. 4 is a sectional view taken along V-IV in FIG. 3;

FIG. 5 is a sectional view taken along V-V in FIG. 3;

FIGS. 6A through 6C are sectional views describing a method for manufacturing the LCD device according to the first embodiment of the present invention.

### DETAILED DESCRIPTION

Reference will now be made in detail to the embodiments of the present invention, examples of which are illustrated in the accompanying drawings, wherein like reference numerals refer to like elements throughout.

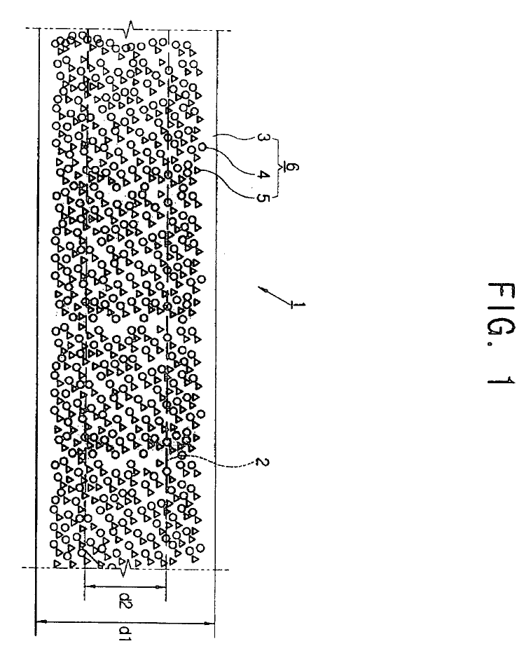

FIG. 1 is a sectional view of a heat conductive sheet 1 according to a first embodiment of the present invention.

The heat conductive sheet 1 comprises woven glass fibers 2 and a coating layer 6 surrounding the glass fibers 2. The coating layer 6 comprises fluoropolymer resin 3, aluminum particles 4, and silicon 5. Also, the particles comprising the coating layer 6 are permeated into the glass fibers 2.

The glass fiber 2 is a mineral fiber made by forming a fiber from molten glass. The glass fiber 2 is resistant to heat and does not burn. Also, the glass fiber 2 does not easily erode because of its chemical durability. Physically, the glass fiber 2 has high tensile strength, low elasticity, and high insulating ability.

A small diameter glass fiber 2 provides improved performance in several characteristics. For example, the small diameter glass fiber 2 provides high tensile strength, which provides high durability for the heat conductive sheet 1. As the glass fibers 2 are not burned by fire and have low elasticity, they prevent the heat conductive sheet 1 from being wrinkled, folded, bent, etc., during the bonding process. Thus, by reusing the heat conductive sheet 1 for multiple fabrication processes, the overall manufacturing cost may be reduced and the time for replacing the heat conductive sheet 1 may be reduced. Also, the bonding between the leads and the pads may be performed with increased stability. The thickness d2 of the glass fiber 2 can be, e.g., about 0.05 mm to 0.15 mm.

The fluoropolymer resin 3 which is included in the coating layer 6 helps the heat conductive sheet 1 to be easily detached from the ACF or TAB-IC. That is, the fluoropolymer resin 3 improves the detachability of the heat conductive sheet 1. Also, to improve the detachability, the fluoropolymer resin 3 is preferably positioned at the outer sides of the heat conductive sheet 1.

A fluoropolymer is a polymer that contains atoms of fluorine. Exemplary fluoropolymers include PTFE (polytetrafluoroethylene), FEP (fluorinated ethylene propylene copolymer), PFA (perfluoroalkoxy), and ETFE (ethylene and tetrafluoroethylene copolymer), all of which are manufactured and sold under the trade name Teflon, which is a trademark of E. I. du Pont de Nemours and Company, of Wilmington, Del.

In this embodiment, fluoropolymer resin 3 forms a continuous matrix, and the aluminum particles 4 and the silicon particles 5 are distributed in the fluoropolymer resin 3. Alternatively, the formation of the coating layer 6 may vary according to the content of each component or addition of another components. For example, the aluminum may comprise continuous phase aluminum instead of the aluminum particles 4. The silicon may also comprise continuous phase silicon. Likewise, the fluoropolymer resin 3 may be provided as particles.

The aluminum particles 4 improve the heat conductivity of the heat conductive sheet 1. If the heat conductive sheet 1 provides improved heat conductivity over conventional methods, the heating tool may utilize lower temperatures during the bonding process. Thus, the electricity needed for heating the heating tool may be reduced and the heat conductive sheet 1 may be used under mild conditions.

The silicon 5 improves the shape adaptability of the heat conductive sheet 1 for the operating environment. When pressed during the bonding process, the shape of the heat conductive sheet 1 is influenced by unevenness around the pads. In this condition, if the heat conductive sheet 1 does not conform to the uneven surface provided by the pads, the conductive particles in the ACF may not properly bond with the surrounding material. Thus, the silicon 5 provides conformal flexibility to allow the head conductive sheet 1 to conform to the unevenness around the pads, so that the ACF may be closely mated with the pads.

In one embodiment, the composition of the coating layer 6 contains 80 to 120 parts by weight of the fluoropolymer resin 3, 80 to 120 parts by weight of the aluminum particles 4, and 100 parts by weight of the silicon 5.

The tensile strength of the heat conductive sheet 1 is preferably 300 kgf/cd or more according to ASTM D638, to provide proper durability. Also, the elasticity of the heat conductive sheet 1 is preferably 10% or less according to ASTM D638 to prevent deformation during the bonding process. The electrical resistance of the surface of the heat conductive sheet 1 is preferably 10¹⁰Ω/cm² or less to maintain proper heat conductivity.

The overall thickness d1 of the heat conductive sheet 1 is preferably 0.15 mm to 0.25 mm. The use of a thickness d1 less than 0.15 mm would result in either a thin glass fiber 2 or a thin coating layer 6. As a result, the heat conductive sheet 1 may have low durability, low detachability, and low shape adaptability. If the thickness d1 is greater than 0.25 mm, the heat conductive sheet 1 may have low heat conductivity.

Table 1 shows physical properties of the heat conductive sheet 1 according to the above-described embodiments and a conventional PTFE sheet.

TABLE 1

| | | | | Surface |
|---|---|---|---|---|
| | | Tensile | | electrical |
| | Hardness | strength | Elasticity | resistance |
| | (Hs) | (kgf/cm²) | (%) | (Ω/cm²) |
| Heat conductive | 55 | 416.2 | 5 | 10⁹ |
| sheet 1 | | | | |
| (thickness of glass | | | | |
| fiber: 0.1 mm) | | | | |
| Heat conductive | 55 | 416.2 | 5 | 10⁹ |
| sheet 2 | | | | |
| (thickness of glass | | | | |
| fiber: 0.12 mm) | | | | |
| Teflon sheet | 56 | 140 | 400 | 10¹⁷ |

In Table 1, the hardness was measured according to ASTM D785. The tensile strength and the elasticity were measured according to ASTM D638 where the test machine was 5800 series of INSTRON company (US).

As shown in the Table 1, the hardnesses of the heat conductive sheet 1, the heat conductive sheet 2, and the conventional PTFE sheet were very similar at 55, 55 and 56 Hs (Shore Hardness), respectively.

However, the tensile strengths of the heat conductive sheets 1 and 2 were each 416.2 kgf/cm², which was higher than the tensile strength of 140 kgf/cm² for the conventional PTFE sheet. High tensile strength provides high durability for the heat conductive sheets. Actual use of the above-mentioned heat conductive sheets in the TAB-IC process showed that whereas the conventional PTFE sheet could be used only once, the heat conductive sheets 1 and 2 were able to be used 10 times or more. The high tensile strength of the heat conductive sheets 1 and 2 were the result of the glass fibers 2 contained in the heat conductive sheet 1 in FIG. 1.

The elasticity of the heat conductive sheets 1 and 2 in the lengthwise direction were both 5%, which was lower than the elasticity of 400% for the conventional PTFE sheet. Low elasticity in the lengthwise direction results in limited deformation during the bonding process, thereby reducing the misalignment between the pads and the lead. The conventional PTFE sheet provided poor bonding quality because of the deformation by heat and pressure during the bonding process. However, as the deformations, such as wrinkling, folding, and bending, are prevented by the use of the heat conductive sheets 1 and 2 according to this embodiment, the bonding quality may be improved.

The surface electrical resistance of the heat conductive sheets 1 and 2 was 10⁹Ω/cm², which was much lower than the surface electrical resistance of 10¹⁷Ω/cm² for the conventional PTFE sheet. As the surface electrical resistance is inversely proportional to the heat conductivity, it will be appreciated that the heat conductivity of the heat conductive sheets 1 and 2 is higher than that of the PTFE sheet. When performing TAB-IC bonding under constant temperature at the heating tool, the use of the heat conductive sheet 1 or 2 produced ACF temperatures higher than the use of the PTFE sheet by about 10° C. Thus, the set temperature of the heating tool when using the heat conductive sheet 1 or 2 may be lowered by about 30° C. relative to the temperatures used for the PTFE sheet to produce an equivalent ACF temperature. The low surface electrical resistance of the heat conductive sheet 1 and 2 is provided by the aluminum particles 4 included therein.

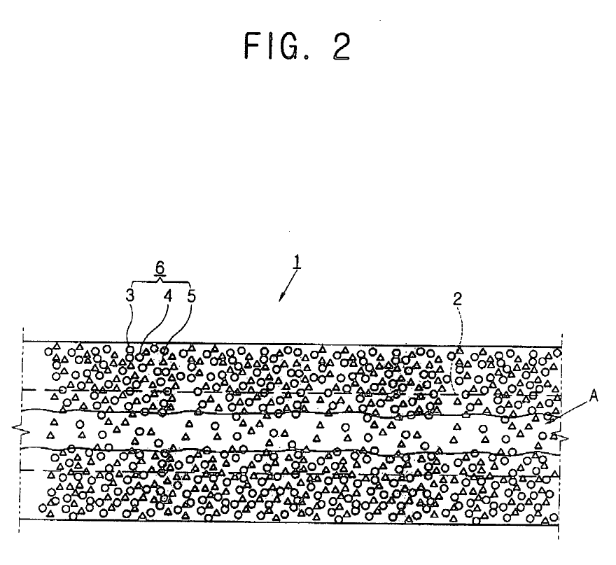

FIG. 2 shows a heat conductive sheet 1 according to a second embodiment of the present invention.

In contrast with the first embodiment of the heat conductive sheet 1 described above with respect to FIG. 1, the density of the coating layer 6 in the center part A of the glass fibers 2 is lowered. This may be achieved by adjusting temperature and pressure during the manufacturing process of the heat conductive sheet 1. This manufacturing process will be described below.

Various modifications to the heat conductive sheet 1 may be made. For example, the aluminum particles 4 may be used together with or be substituted by other metal particles. Also, the distribution of the fluoropolymer resin 3, the aluminum particles 4, and the silicon 5 in the coating layer 6 may be modified according to position in the coating layer 6.

A method for manufacturing the heat conductive sheet 1 is as follows. First, the glass fiber 2 and coating components are provided. The coating components comprise the fluoropolymer resin 3, the metal particles 4, and the silicon 5. These coating components may be in a phase of paste or powder.

Then, the glass fiber 2 and the coating components are combined by hot-pressing. The temperature of the hot-pressing is preferably 400° C. to 600° C. During the hot-pressing, the coating components are mixed and bonded with each other to form the coating layer 6. The coating layer 6 is formed in the glass fiber 2 as well as outside of the glass fiber 2. The amount and density of the coating layer 6 provided in the glass fiber 2 may be varied by adjusting the conditions of the hot-pressing, such as temperature, pressure, and duration of the hot-pressing step.

The heat conductive sheet 1 formed by the method described above has the physical characteristics of the glass fibers 2 because the coating layer 6 is united with the glass fibers 2. Also, the fluoropolymer resin 3, the metal particles 4, and the silicon 5 in the coating layer 6 are united and are not separated from each other during the bonding process.

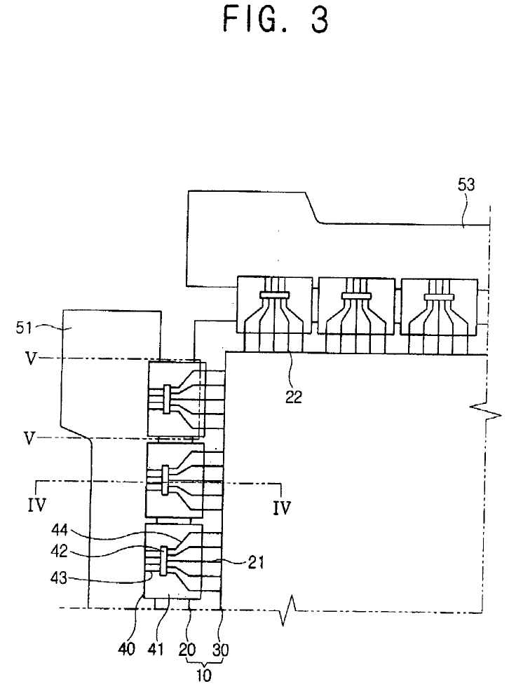

An LCD device manufactured according to the first embodiment of the present invention will now be described with reference to FIGS. 3 through 5.

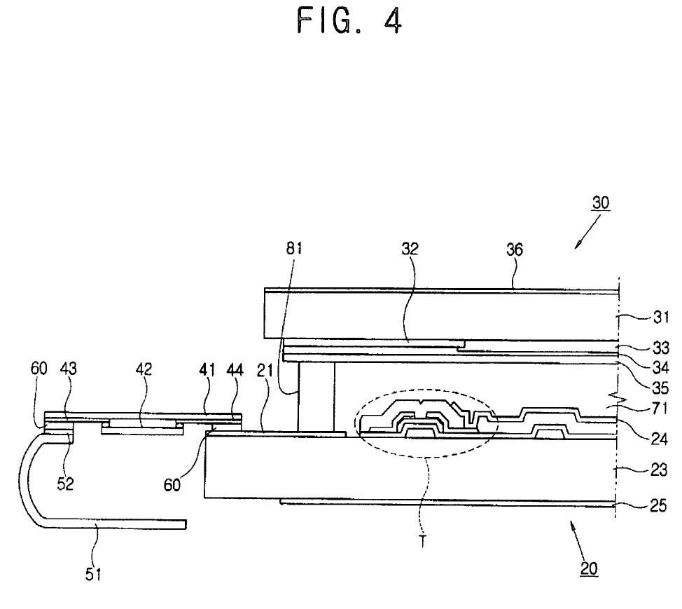

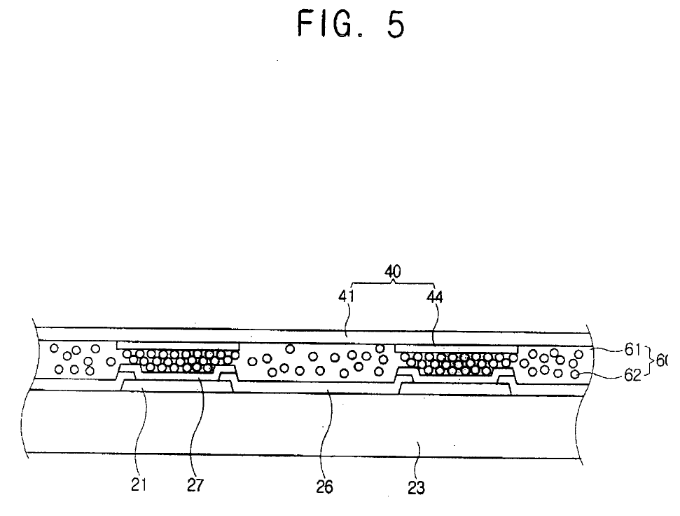

FIG. 3 is a plan view showing the arrangement of elements of an LCD device according to the first embodiment of the present invention. FIG. 4 is a sectional view taken along IV-IV in FIG. 3. FIG. 5 is a sectional view taken along V-V in FIG. 3. In this embodiment, a COF 40 is used as the TAB-IC.

The LCD device comprises an LCD panel 10 having a TFT substrate 20 and a color filter substrate 30. The COF 40 is attached to the periphery of the TFT substrate 20, and circuit boards 51, 53 coupled to the COF 40. The LCD device further comprises a liquid crystal layer 71 located between the TFT substrate 20 and the color filter substrate 30. The LCD device may further comprise a backlight unit (not shown) at the backside of the TFT substrate 20.

On an upper part of a substrate material 23 of the TFT substrate 20 are provided gate pads 21 extending from gate lines and data pads 22 extending from data lines.

The following description relates to the structure to drive gate lines connected to the gate pads 21. It will be understood that a similar structure may also be used to drive data lines connected to the data pads 22.

A plurality of TFT's T are formed on the TFT substrate 20. The TFT's T are provided at the regions where the data lines and the gate lines intersect. The TFT T shown in FIG. 4 is a type of TFT manufactured using five masks. The TFT T receives a driving signal from the COF 40 through the gate pad 21 positioned at a non-display area. The gate pad 21 is positioned at a distal part of the gate line and has a width wider than that of the gate line. If the TFT T is activated by the driving signal, a voltage is applied to a pixel electrode 24 coupled to the TFT T. The pixel electrode 24 comprises a transparent conductive material, such as ITO (indium tin oxide) and IZO (indium zinc oxide).

The structure of the color filter substrate 30 is as follows. A black matrix 32 and a color filter layer 33 are formed on the substrate material 31. Generally, the black matrix 32 partitions the red pixels, green pixels, and blue pixels from each other and serves to intercept direct irradiation to the TFT T. The black matrix 32 may comprise a photosensitive organic material including a black pigment. The black pigment may include carbon black, titanium oxide, etc.

The color filter layer 33 comprises red filters, green filters, and blue filters which are formed in a repeated pattern with boundaries set by the black matrix 32. The color filter layer 33 provides color to the light which has been irradiated from the backlight unit (not shown) and has passed through the liquid crystal layer 71. Generally, the color filter layer 33 comprises a photosensitive organic material.

An overcoat layer 34 is formed on the color filter layer 33 and an upper part of the black matrix 32 which is not covered by the color filter layer 33. The overcoat layer 34 protects the color filter layer 33 and may comprise an acryl epoxy.

A common electrode layer 35 is formed on the overcoat layer 34. The common electrode layer 35 comprises a transparent conductive material such as ITO (indium tin oxide) and IZO (indium zinc oxide) . The common electrode layer 35 applies a voltage to the liquid crystal layer 71 along with the pixel electrode layer 24 on the TFT substrate 20.

Further, each of the TFT substrate 20 and the color filter substrate 30 has polarizing plates 25 and 36 on their outer surfaces. The liquid crystal 71 is contained in a region defined by the TFT substrate 20 the color filter substrate 30, and a sealant 81, which is provided along the periphery of the substrates 20, 30 and is adhered to both substrates 20, 30. The arrangement of the liquid crystal 71 varies according to the driving signal at the COF 40.

The connection between the COF 40, the LCD panel 10, and the PCB 51 is as follows.

The COF 40 comprises wiring layers such as an input lead 43 and an output lead 44, a driving circuit 42, and a film 41 on which the wiring layers and the driving circuit 42 are mounted. The driving circuit 42 is coupled to both the input lead 43 and the output lead 44. The input lead 43 is coupled to a signal pad 52 of the circuit board 51 and the output lead 44 is coupled to the gate pad 21. Each of the leads 43, 44 and each of the pads 52, 21 are electrically coupled to each other through an ACF 60. The ACF 60 comprises a resin layer 61 and conductive particles 62 distributed in the resin layer 61. The conductive particles 62 provide electrical conductivity between the leads 43, 44 to the pads 52, 21, respectively. An insulating film 26 is removed on a center portion of the gate pad 21. The center portion is covered by a contact member 27 which is made of ITO (indium tin oxide) or IZO (indium zinc oxide). Thus, the gate pad 21 is electrically coupled to the output lead 44 through the conductive particles 62 and the contact member 27.

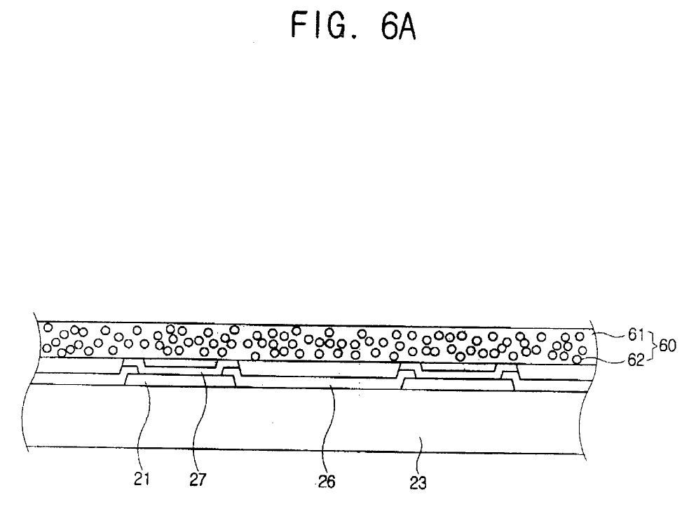

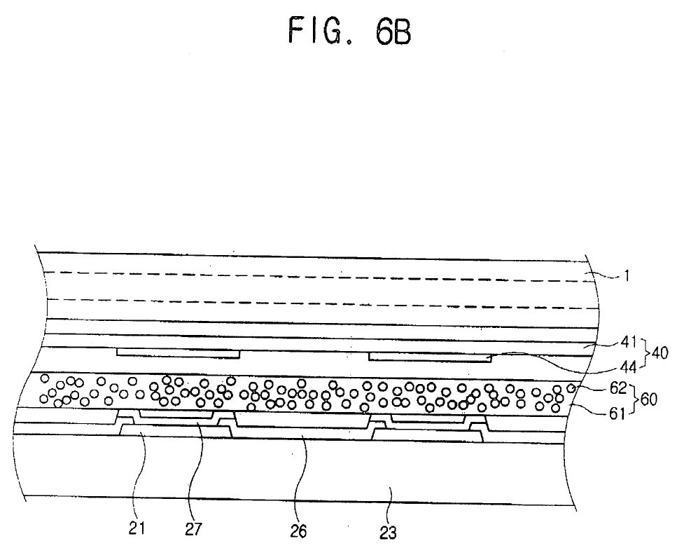

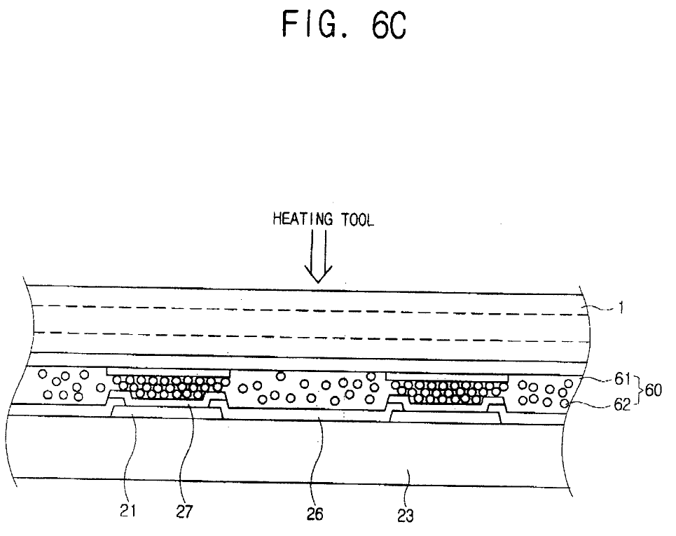

A method for manufacturing the LCD device according to the first embodiment of the present invention is provided as follows with reference to FIGS. 6A through 6C.

First, as shown in FIG. 6A, the insulating film 26 on the center portion of the gate pad 21 is removed and the contact part 27 is formed on the center portion. Next, the ACF 60 is placed on the gate pad 21. As it can be seen in FIG. 6A, the gate pad 21 produces an uneven upper surface. A passivation film to be coated on the insulating film 26 may be further removed at the center portion of the gate pad 21. The contact member 27 may optionally be omitted.

Then, as shown in FIG. 6B, the COF 40 and the heat conductive sheet 1 according to the present invention are positioned on the ACF 60. The COF 40 is positioned such that the output leads 44 of the COF 40 correspond to the gate pads 21. Also, the output leads 44 and the gate pads 21 may be provisionally bonded before positioning the heat conductive sheet 1 on the ACF 60. The provisional bonding may be performed similar to the bonding process described above, but at lower temperatures. For the provisional bonding, the temperature of the ACF 60 is preferably 80C and an additional shock-absorbing sheet is not necessary.

Then, as shown in FIG. 6C, the heating tool is pressed downward onto the heat conductive sheet 1 so that the output leads 44 are compressed onto the gate pads 21. During the pressing process, the set temperature of the heating tool is 370° C. to 390° C., which is lower than when the conventional PTFE sheet is used. This is because the heat conductive sheet provides excellent heat conductivity, as a result of the aluminum particles 4 included in the heat conductive sheet 1. Because of the pressing of the heating tool, the temperature of the heat conductive sheet 1 rises to approximately 250° C. to 300° C., and the temperature of the ACF 60 rises to approximately 190° C. As a result of the pressure applied by the heating tool, the gate pads 21 and the output leads 44 are electrically connected through the conductive particles 62, and the resin layer 61 of the ACF 60 is hardened to complete the bonding.

As the heat conductive sheet 1 is not easily deformed after the bonding process above, a stable bonding may be achieved. Also, during the bonding process, the heat conductive sheet 1 is flexibly deformed according to the shape of the bonding surface by the silicon 5. Thus, the gate pad 21 and the output lead 44 may be closely contacted.

As the heat conductive sheet 1 has high durability, it may be reused after having been used in a bonding process.

Although a few embodiments of the present invention have been shown and described, it will be appreciated by those of ordinary skill in the art that changes may be made in these embodiments without departing from the principles and spirit of the invention, the scope of which is defined in the appended claims and their equivalents.

What is claimed is:

1. A heat conductive sheet comprising:
glass fiber; and
a coating layer surrounding the glass fiber, said coating layer comprising silicon, a fluoropolymer resin, and metal.

2. The heat conductive sheet according to claim 1, wherein the metal comprises aluminum.

3. The heat conductive sheet according to claim 1, wherein the coating layer comprises 80 to 120 parts by weight of the fluoropolymer resin, 80 to 120 parts by weight of the metal, and 100 parts by weight of the silicon.

4. The heat conductive sheet according to claim 1, wherein the glass fiber is permeated by particles from the coating layer.

5. The heat conductive sheet according to claim 4, wherein a density of the coating layer particles in the glass fiber is greater at an outer radial region of the glass fiber than at a central radial region of the glass fiber.

6. The heat conductive sheet according to claim 4, wherein the glass fiber is permeated by particles comprising at least one of the fluoropolymer resin, the silicon, and the metal.

7. The heat conductive sheet according to claim 1, wherein the thickness of the glass fiber is 0.05 mm to 0.15 mm.

8. The heat conductive sheet according to claim 1, wherein the thickness of the heat conductive sheet is 0.15 mm to 0.25 mm.

9. The heat conductive sheet according to claim 1, wherein the tensile strength of the heat conductive sheet is 300 kgf/cm² or more.

10. The heat conductive sheet according to claim 1, wherein the elasticity of the heat conductive sheet is 10% or less.

11. The heat conductive sheet according to claim 1, wherein the surface electrical resistance of the heat conductive sheet is 10¹⁰Ω/cm² or less.

12. The heat conductive sheet according to claim 1, wherein the fluoropolymer resin is continuous phase.

13. A method for manufacturing a heat conductive sheet comprising:
providing a coating composition comprising silicon, fluoropolymer resin, and metal; and
hot-pressing the coating composition onto a glass fiber.

14. The method for manufacturing the heat conductive sheet in claim 13, wherein the temperature of the hot-pressing is 400° C. to 600° C.

15. A method for manufacturing a liquid crystal display (LCD) device comprising:
providing a heat conductive sheet comprising a glass fiber, a coating layer comprising silicon, fluoropolymer, and metal;
aligning leads on a lead layer coupled to a driving circuit with pads formed on an LCD panel, with a conductive film provided between the leads and the pads;
positioning the heat conductive sheet adjacent to a side of the lead layer opposite the pads; and
applying a pressure to the heat conductive sheet using a heating tool.

16. The method for manufacturing the LCD device according to claim 15, wherein the metal comprises aluminum.

17. The method for manufacturing the LCD device according claim 15, wherein the set temperature of the heating tool during said applying the pressure is 370° C. to 390° C.

18. The method for manufacturing the LCD device according to claim 15, wherein the temperature of the heat conductive sheet during said applying the pressure is 250 to 300° C.
